(19) United States
(12) Patent Application Publication
(10) Pub. No.: US 2005/0052457 A1
(43) Pub. Date: Mar. 10, 2005

(54) Apparatus for generating and displaying images for determining the quality of audio reproduction

(76) Inventors: Neil Muncy, Markham (CA); Ketan Bhaidasna, Jamesburg, NJ (US); Eric Small, Monroe Township, NJ (US)

Correspondence Address: MILDE, HOFFBERG & MACKLIN, LLP, SUITE 460, 10 BANK STREET, WHITE PLAINS, NY, 10606, US

(21) Appl. No.: 10/645,103

(22) Filed: Aug. 21, 2003

Related U.S. Application Data
(60) Provisional application No. 60/450,571, filed on Feb. 27, 2003.

(51) Int. Cl. G06T 11/20

(52) U.S. Cl. 345/440

(57) ABSTRACT

A display processor, connected to receive left and right total audio signals, Lt and Rt, respectively, produces display control signals for a graphic image display which displays a two dimensional image within an X and Y coordinate system. According to the invention, the relative in-phase components of the signals Lt and Rt are represented as positive Y coordinate points in the image, whereas the relative out-of-phase components of the signals Lt and Rt are represented as negative Y coordinate points in the image. Furthermore, the respective amplitudes of the signals Lt and Rt are represented as negative X and positive X coordinate points, respectively, in the image.

### CROSS-REFERENCE TO RELATED APPLICATION

This application is related to, and claims priority from, U.S. Provisional Application No. 60/450,571, filed Feb. 27, 2003.

### BACKGROUND OF THE INVENTION

The present invention relates to an apparatus for generating and displaying images for determining the quality of audio reproduction in a surround sound system of the type that transmits a left total audio signal (hereinafter “Lt Signal”) and a right total audio signal (hereinafter “Rt Signal”).

The video portion of television signals, analog or digital, can be relatively easily quality controlled by automatic means. Maintenance of a broadcast quality picture does not require that a skilled technician be viewing a monitor. The underlying reasons for the relative ease of automated monitoring of picture quality arises from the redundant nature of images and from the sequential manner in which television pictures are transmitted.

The audio portion of a television signal is vastly different from the video. The aural signal is almost without automatic quality control tools. Another commonly employed device is a crude “silence sensor” for alarming an engineer in the case of total absence of sound programming. Such a sensor can even be fooled by the presence of tone or noise, instead of program material.

The situation became even more complex as first stereophonic sound, then two transmission channel “surround sound” (especially Dolby® Surround), and finally six transmission channel “5.1” was added to the aural stage. Significantly, each of these new modes added additional degrees of apparently statistically independent randomness to the aural signal.

For example, stereo added a second independent channel that could randomly vary in amplitude, as could the original monaural channel. Then, in addition, a parameter of correlation between the two stereo channels was added.

To further complicate matters, the need for stereophonic signals to maintain compatibility with monaural reception added a whole range of forbidden conditions, because the signal might continue to sound good in stereo, but would cancel or otherwise sound unacceptable when summed into monaural. Some automated equipment to alarm a loss of correlation between left and right channels become available, but in the main, only careful subjective monitoring of the stereo and mono signal by a skilled listener/engineer, in the production phases of the audio program, could assure monaural compatibility.

The addition of two transmission channel surround technology to sound for video imaging vastly exacerbated the monitoring problem.

Today, many major events and programs are produced in six channel 5.1 audio. With six independent transmission channels the audio producer/engineer/mixer has complete artistic freedom. The monitoring is done with six speakers and anything the mixer can hear can be transmitted. A serious problem arises because only a tiny percentage of the audience is listening in true 5.1. The rest are listening in monaural, stereo, and two transmission channel Dolby Pro Logic®. Most listeners with home theater systems listen in Pro Logic format.

The conversion from 5.1 to Pro Logic is done automatically by the Dolby professional surround encoder. However, there are many conditions that can be created in 5.1 that will sound fine in 5.1 but will result in unacceptable reproduction in Pro Logic, stereo and/or monaural.

A discussion of the Dolby Pro Logic System may be found at www.Dolby.com/tech/whtppr.html. This technical article, entitled “Dolby Surround Pro Logic Decoder Principles of Operation”, explains that a left total audio signal Lt and a right total audio signal Rt are generated from the 5.1 format by a so-called “MP Matrix Encoder”. The outputs Lt and Rt of the encoder are audio bandwidth analog signals which contain the original amplitude and phase information (with some information loss). Depending upon the ultimate use of these audio signals Lt and Rt (for example, for television broadcast, home entertainment system, or the like) the signals Lt and Rt must be decoded by a Pro Logic decoder. The principles of operation of this decoder are explained in the aforementioned Dolby technical article.

Initially, surround program sources, such as 5.1, were limited to the sound tracks of major motion pictures which are carefully controlled and skillfully crafted. Especially as a result of the efforts of Dolby Laboratories, the introduction of surround to motion picture audio was done with artistic and technical excellence, and the industry has maintained this level of quality. However, by its very success, the pressure to produce in surround has moved further down the production chain. As home theater systems have proliferated, a demand arose for “movie quality sound” in television syndication. Like film, TV syndication usually has the technical expertise to do a good job, although not always the time and budget of Hollywood. Some of their early mistakes did get on the air, although problems are rare today.

Today the demand is for surround encoding of the audio of live television production, and perhaps the most demanding of all, live sports. Not only are sports the ultimate in live, unscripted programming, but the production and technical facilities are often crammed into a few forty foot trailers parked near a sports stadium. Surround monitoring facilities, if they exist at all, are less than ideal. Add to this problem a sound mixer who barely has time to insure that the correct microphones are on-air when needed, let alone worrying about compatibility of the surround mix.

In particular; the two channel Dolby Surround signals Lt and Rt must be produced in such a way that they remain “downward compatible”: that is, so that they may be listened to on conventional stereo audio systems and summed to create an acceptable monaural signal. This downward compatibility is only achievable if the original audio information is properly mixed. The process of assembling many discrete sound sources into an audio program is called “mixing”. Such mixing is carried out by human engineers called “mixers” who utilize complex mixing consoles and calibrated monitoring systems. During a live, real world program, mixers are extremely busy making artistic decisions regarding the level, balance and position of the active microphones. Normally, monitoring is carried out in only one mode; that is, surround 5.1. During a live program, there is no time to switch to other playback modes such as Pro Logic decode stereo or mono, to insure the downward compatibility. The mixer simply depends upon his experience not to create incompatible mixes. Unfortunately, given the time constraints, errors do occur.

One solution to the problem of producing downward compatible two channel Dolby Surround signals is to perform a different mix for each release format. While this would be possible for motion picture releases, and has been done, it is unnecessarily expensive. Such a solution is not at all possible in broadcasting, however, because one transmission stream must serve for all types of receivers.

The problem of downward compatibility is most acute in television broadcasting. Most local television stations are merely switching centers for selecting one television source after another to put on the air. Typically, local news is the only material that is actually produced at the station itself. All other sources are either a live feed or pre-recorded segments. Often, a single technician operates the entire television station, with the aid of automation. Quality control of the program is an important part of this technician's job. Whereas various measuring elements and alarms are available to draw the technician's attention to possible problems with the video portion of the program, there is no equivalent automated objective technique for monitoring the audio portion of the program material.

### SUMMARY OF THE INVENTION

It is therefore a principal objective of the present invention to provide apparatus which allows for rapid objective assessment of many aspects of 5.1 surround sound and its derivative products: Dolby Surround sound, conventional stereophonic sound and conventional monaural sound.

A more particular objective of the present invention is to provide an apparatus for dealing with issues such as channel balance, microphone placement and microphone separation, by presenting a mixing engineer with a real time graphic image during the mixing process which aids in quality control and with which limits can be set on the allowable incompatibility in various signal formats.

These objects, as well as further objects which will become apparent from the discussion that follows, are achieved, by providing a display processor, connected to receive the Lt and Rt signals, for producing display control signals for a graphic image display which displays a two dimensional image within an X and Y coordinate system. According to the invention, the relative in-phase components of the signals Lt and Rt are represented as positive Y coordinate points in the image, whereas the relative out-of-phase components of the signals Lt and Rt are represented as negative Y coordinate points in the image. Furthermore, the respective amplitudes of the signals Lt and Rt are represented as negative X and positive X coordinate points, respectively, in the image.

In a preferred embodiment of the invention, the signal Lt is comprised of signal elements unique to the left sound channel only (Lo), plus equal level and in-polarity signal elements common to both Lt and Rt (C), plus equal level but out-of-polarity signal elements common to both Lt and Rt (Surr). Similarly, the signal Rt is comprised of signal elements unique to the right sound channel only (Ro), plus equal level and in-polarity signal elements common to both Lt and Rt (C), minus equal level but out-of-polarity signal elements common to both Lt and Rt (−Surr).

In the embodiment referred to above, the display processor calculates each X-Y coordinate point for display in accordance with the following formulae:
Y=C+(−Surr); and
X=−Lo+Ro.

In an analog implementation of the invention, the display processor processes the signals Lt and Rt in analog form, to produce analog display control signals at its output. In this implementation the display processor produces an analog X coordinate control signal by summing the outputs of (1) a first full wave rectifier which is connected to the left audio signal input to receive the signal Lt and which produces a negative output signal, and (2) a second full wave rectifier which is connected to the right audio signal input to receive the signal Rt and which produces a positive output signal.

Similarly, in this analog implementation, the display processor produces an analog Y coordinate control signal by first producing first and second intermediate signals representing the sum and difference, respectively, of the signals Lt and Rt; passing the first intermediate signal though a first full wave rectifier which produces a positive third intermediate signal; passing the second intermediate signal through a a second full wave rectifier which produces a negative fourth intermediate signal; summing the third and fourth intermediate signals to produce a fifth intermediate signal; passing the fifth intermediate signal through a first half wave rectifier to produce a positive sixth intermediate signal; passing the fifth intermediate signal through a second half wave rectifier to produce a seventh intermediate signal and then summing the sixth and seventh intermediate signals together.

The analog display processor preferably comprises a display compression generator connected to a gain control amplifier at the processor output to adjust the gain of the X coordinate control signal.

The analog display processor also preferably comprises a display compression generator connected to a gain control amplifier at the processor output to adjust the gain of the Y coordinate control signal.

Finally, the analog display processor preferably also comprises an amplifier connected to the output of the first half wave rectifier to increase the gain of the sixth intermediate signal.

In a digital implementation of the invention, the display processor samples the signals Lt and Rt at a given sampling frequency to produce digital signals and processes the digital signals in digital form to produce digital display control signals at the processor output. The sampling frequency is preferably at least twice the maximum frequency of the the signals Lt and Rt to preserve all the original signal information in the digital signals.

Once the Lt and Rt signals are digitized, the display processor calculates the digital X and Y coordinates of each successive point to be displayed. The display processor calculates and stores a plurality of points to produce a scatter plot as a single image frame and thereafter passes this image frame to the processor output for display. A plurality of image frames, each comprising a scatter plot, are then displayed sequentially to form a video image on the display screen.

In a preferred embodiment of the invention, the display processor calculates the arithmetic mean point of all points in each scatter plot for which the Y coordinate is positive, and generates a first straight line from the origin, where X and Y are both zero, to this positive arithmetic mean point, for imaging on the display screen. Additionally also, the display processor calculates the arithmetic mean point of all points in the scatter plot for which the Y coordinate is negative, and generates a second straight line from the origin, where X and Y are both zero, to the negative arithmetic mean point, for imaging on the display screen. The first line is preferably displayed in one color, such pink or red, and the second line is displayed in another color, such as green or blue.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is an example of a graphic image display for displaying a two dimensional image within an X and Y coordinate system.

FIG. 2 comprises four basic X-Y displays of stereophonic sound: left channel only, right channel only, in-polarity monaural and out-of-polarity monaural signal.

FIG. 3 comprises two stereophonic X-Y displays for an in phase, mono compatible stereo signal and a stereo signal with polarity inversion.

FIG. 4 comprises two stereo X-Y displays showing uncorrelated stereo signals consisting of totally random phase information and stereo signals with occasional moments of out-of-phase information.

FIG. 5 is a SpiderGraph™ display of left total and right total (Lt and Rt) audio signals, in accordance with the present invention.

FIG. 6 comprises four SpiderMesh™ displays in which interchannel phase and polarity information are directed to different areas of the screen.

FIG. 7 comprises six different SpiderGraph™ displays, in accordance with the present invention, illustrating images created by different types of input signals.

FIG. 8 is a reproduction of an actual SpiderGraph™ display screen, showing the SpiderMesh™ and SpiderVector™, in accordance with the present invention, which was generated from Lt and Rt signals which were left heavy and contained surround sound information.

FIG. 9 is another reproduction of an actual SpiderGraph™ display which was generated from Lt and Rt signals which contained all surround sound channels.

FIG. 10 is still another reproduction of an actual SpiderGraph™ display which was generated from Lt and Rt signals with center and surround sound information.

FIG. 11 is a block diagram of the SpiderVision™ system according to the present invention.

FIG. 12 is a block diagram of an analog display processor, which may be used with the SpiderVision™ system of FIG. 11.

FIG. 13 is a block diagram of a digital display processor, which may be used with the SpiderVision™ system of FIG. 11.

FIG. 14 is a flow chart showing the operation of the microcomputer of FIG. 13.

### DETAILED DESCRIPTION OF THE PREFERRED EMBODIMENTS

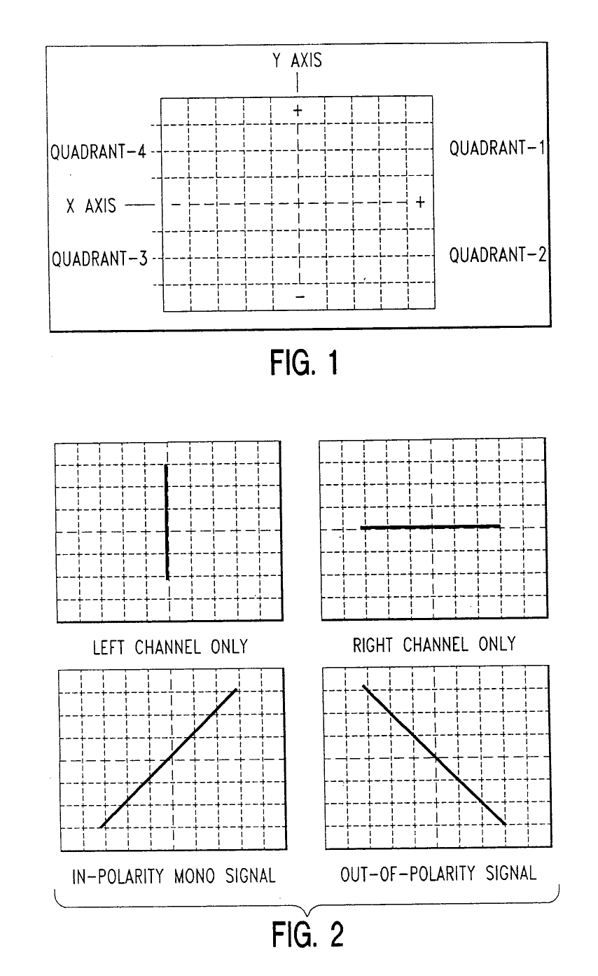

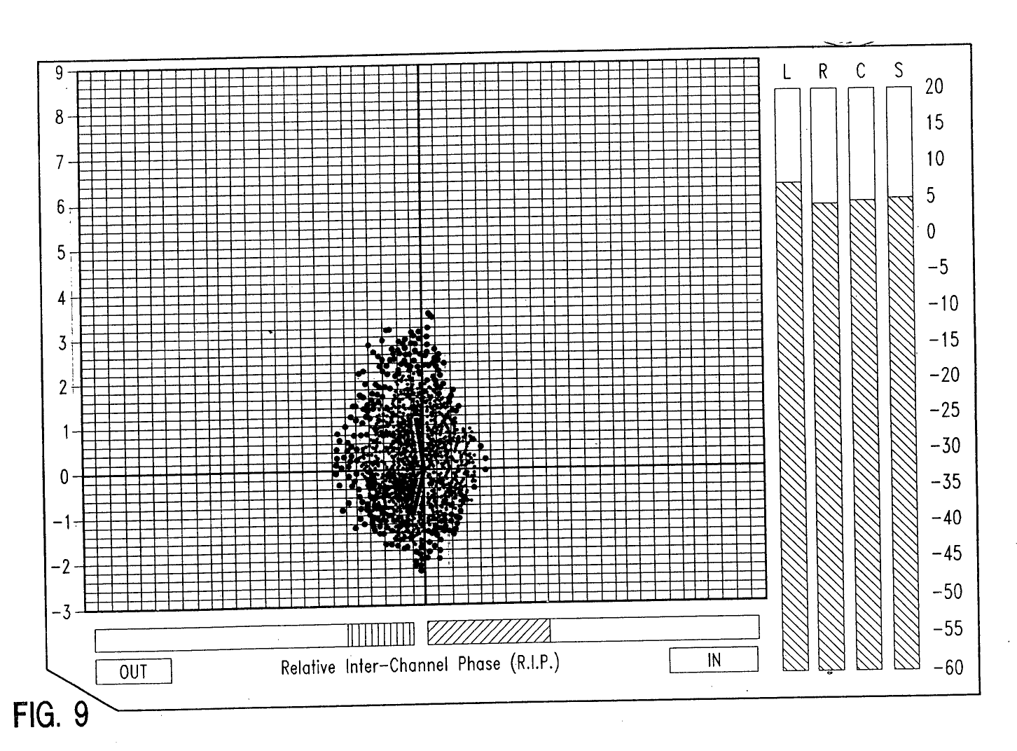

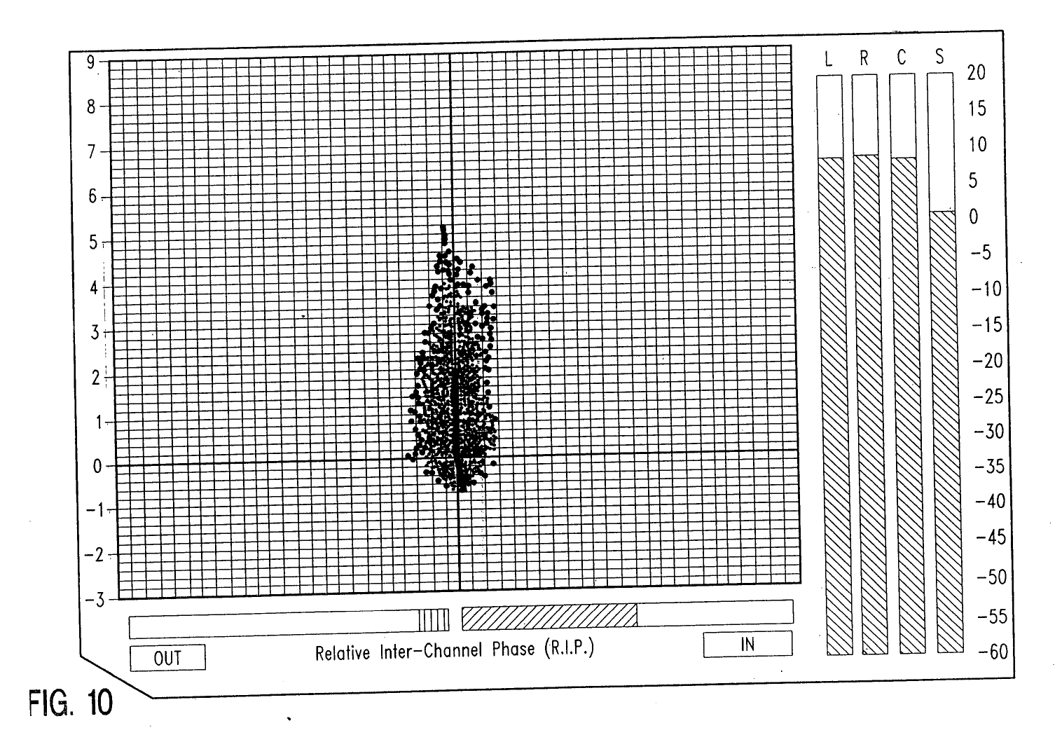

The preferred embodiments of the present invention will now be described with reference to FIGS. 1-14 of the drawings. Identical elements in the various figures are designated with the same reference numerals.

In this text, reference is made to the terms SpiderVision™, SpiderGraph™, SpiderMesh™ and SpiderVector™. These terms, which are defined hereinafter, are trademarks of Modulation Sciences, Inc.

The concept of displaying multi-channel audio as an instantaneous vector on some form of an X-Y display (as with an oscilloscope, for example) is nearly as old as stereophonic sound recording and reproduction itself. This type of display is the basis of SpiderVision since it delivers unique information about the signals, although not positional data. Set forth below is a discussion of the traditional X-Y display. Although this discussion is based on an X-Y oscilloscope display, it applies to any device that can display rectangular coordinate information, such as any type of real time computer display.

An Introduction to X-Y Displays

Stereo audio signals consist of five principal components:
Components, which are unique to the Left channel.
Components, which are unique to the Right channel.
In-polarity signals common to both channels.
Out-of-polarity signals common to both channels.
Random phase signals occurring in both channels.

The random phase component can be further subdivided into in-phase (<±90°) elements, and out-of-phase (>±90°) elements. The continuously changing amplitude and phase relationships between these five components are of fundamental importance, because they determine mono compatibility and stereo width in all programs, and specific directional placement in surround sound mixes.

Oscilloscope displays have been used for years to observe this complex stereo information. The Left channel signal is applied to the vertical, or “Y” axis, and the Right channel signal is applied to the horizontal, or “X” axis. The size of the resulting “X-Y” screen display is linearly related to the amplitude of the information in the two signal channels. The angle of the display is directly related to the inter-channel relative phase and panning position information. This information can be very useful during the production of stereo programs of all kinds.

An X-Y screen is shown in FIG. 1. The screen is divided into four quadrants. Positive-going signals applied to the Y axis will cause the beam to deflect upwards. Positive-going signals applied to the X axis will cause the beam to deflect to the right. Negative-going signals produce deflection down and to the left, respectively.

The instantaneous absolute polarity of a signal applied to either input can be determined by observing where the trace is located with respect to the four quadrants of the screen at any particular instant in time. The persistence of an LCD or CRT display causes the impression that the beam is spread out over a large area of the screen, when in fact the beam can only be in one spot at any given time.

Basic X-Y displays are shown in FIG. 2. A left-channel-only signal produces a vertical trace. A right-channel-only signal produces a horizontal trace. In-polarity signals in both channels (which, by definition, do not incorporate any interchannel time differences) will produce a trace in quadrants 1 and 3. The same signal, with a polarity inversion in one channel, produces a trace in quadrants 2 and 4. If the amplitudes of these signals are equal, the angle of the display will be 45°, or −45° respectively.

Typical stereo X-Y displays are shown in FIG. 3. Signals with a high degree of phase correlation will produce a trace with most of the display located in quadrants 1 and 3. The same signal with a polarity inversion in one channel will produce a trace with most of the display located in quadrants 2 and 4.

Uncorrelated stereo signals, consisting of totally random phase information, will produce a circular display which looks like a bird's nest. Signals with occasional moments of out-of phase information, will produce a pattern which is continuously changing quadrants, as shown in FIG. 4. The dynamic range of a conventional 8×10 cm X-Y display is limited to about 24 dB.

X-Y Display Limitations

X-Y displays can be confusing, due to the way in which the signal information is presented on the display screen. Because all of the signal information is rapidly changing, and is superimposed on the screen in an overlapping manner, the resulting display is often very difficult to quickly decipher. This constant parade of change can be visually confusing, especially to an operator or mixer who cannot tolerate too many distractions in the midst of other production responsibilities. Additionally, most oscilloscopes have unbalanced inputs, which complicates their connection to many sound systems without hum problems. In spite of the insight they provide, X-Y displays are often ignored because of these factors, if they are used at all.

The SpiderVision System

The SpiderGraph oscilloscope display format generated by the SpiderVision display processor, replaces the conventional X-Y format, and significantly reduces confusion in interpreting the meaning of the display. In this new format, the stereo signal is first disassembled into its five principal components, and then reassembled in a manner which makes much better use of the display screen.

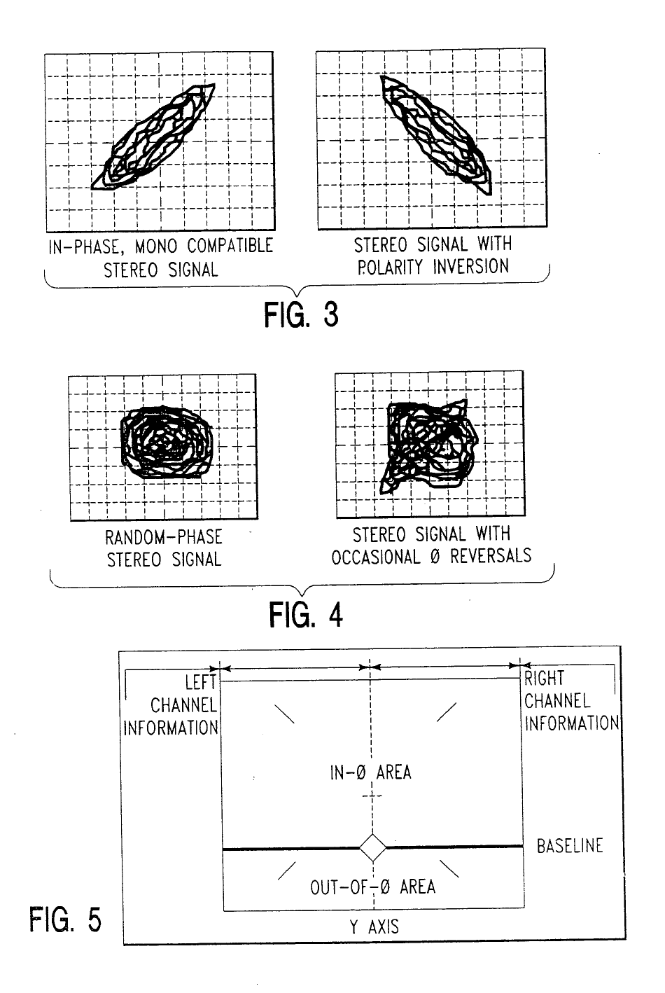

The display processor assigns all Left channel information to the left side of the screen, and all Right channel information to the right side of the screen. In-phase signal components are assigned to the area above the horizontal baseline, and out-of-phase components are directed to the area below the baseline, as shown in FIG. 5.

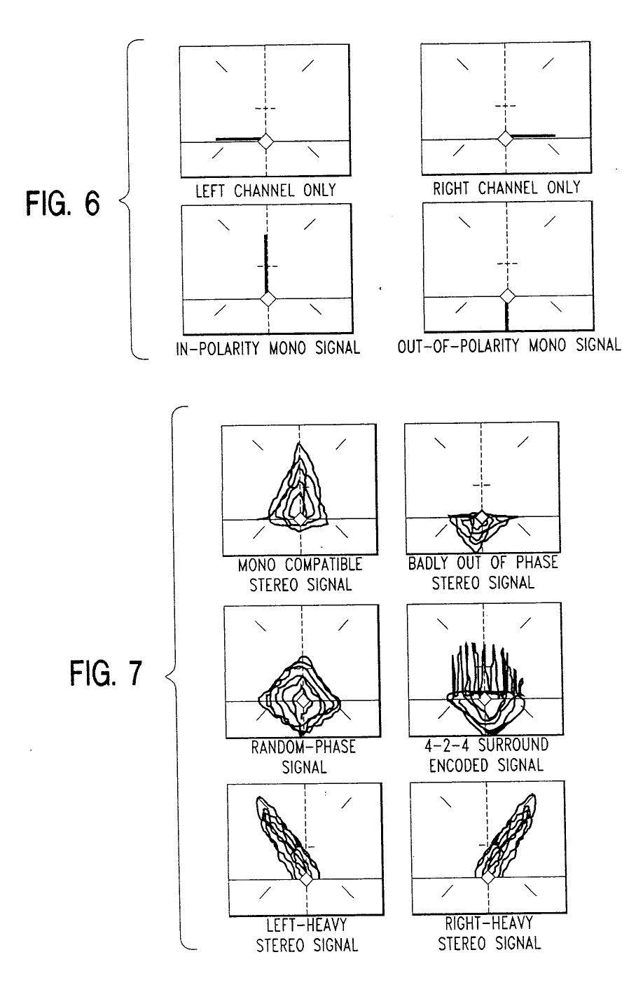

A clear distinction between left-right panning position, and interchannel phase and polarity information, can now be made, because these two types of information are directed to different areas of the screen, as shown in FIG. 6. This feature can be especially useful in the creation and quality control of film and video soundtracks produced with any of the currently available 4-2-4 matrix surround sound encoding systems.

The SpiderMesh Display makes much more efficient use of the X-Y screen, because the signal components no longer overlap each other. The price paid for this improvement is the loss of information regarding the absolute polarity of the information in each channel. Switching back to the X-Y mode restores this capability.

The SpiderVision display processor incorporates a fast-acting display compression circuit which considerably increases the on-screen dynamic range of the display. Input signals from about −25 dB below the system “0” level, up to about +14 dB above the “0” level, will produce a usable on-screen display.

Several stereo displays are shown in FIG. 7. The display processor virtually eliminates ambiguity in the interpretation of the display, as the distinctive and unique shape of each display quickly tells all that is required in normal routine operation.

Operational Description of the SpiderVision System

The SpiderVision surround sound display processor produces a 2-axis visual display, which separates incoming Lt and Rt signal components into elements, which can then be recombined in a manner in which left channel information is directed to the left of the vertical crosshair line, and right-channel information is directed to the right of the vertical crosshair line. The in-phase components of the two input signals are displayed above the horizontal crosshair line. Out-Of-Phase Signal content is directed to the area of the screen display below the horizontal crosshair line. The result is a continuous display of a plurality of lines or points bearing which are called “SpiderMesh”.

SpiderVision, according to the invention, includes the following features and display information:
1. Extraction and display of additional data from the basic SpiderMesh information.
   Two sharp, bright lines track the central tendency of front and the surround portions of the SpiderMesh display respectively. Each of these lines is called a SpiderVector. These lines are so accurate that when keyed into the bottom center of a video image, the front SpiderVector will point to the center of audio action on the screen. The angle of the SpiderVector thus provides the angular information about the audio action, while the length of the line indicates the amplitude of the signal.
2. Display of additional information about the audio, mostly unrelated to the SpiderMesh data.
   This display includes signal amplitude in VU and PPM, as well as absolute peak. Various additional visual devices to hold peak and valley information are included These will retain their values for long periods or even until cleared. Left/Right channel correlation indicating devices such as conventional X-Y displays, meters and various types of bar graphs. It is possible also to display an image representing true program loudness verses time, as well as frequency verses amplitude (such as FFT).
3. Extraction of data from the SpiderGraph information for use in non-graphic applications.
   If all the display processing is digital, it becomes relatively easy to extract numeric values for many of the parameters being measured. This makes it easy to alarm critical parameters to bring potentially forbidden audio conditions to the attention of the operator, as well as maintain a continuing log of the state of the audio. Such a log would be of great value to a TV station where it may take several days for written or emailed complaints about the audio to arrive. With such a log, the status of the audio at the time of the complaint can easily be recalled. In the never ending disputes between program providers, such as networks, syndicators, and commercial producers, one or more SpiderVision units monitoring incoming program material, and one monitoring off-the-air, would make “fixing the blame” an objective activity.

The SpiderVision stereo display processor, according to the invention, can be either an analog or digital signal processing device. The distinctive SpiderGraph display format, generated by the display processor, replaces the conventional X-Y display format, significantly reduces confusion in interpreting the meaning of the display, and makes the display more user-friendly.

The SpiderGraph display enhances the ability of an operator to quickly detect phase problems which affect mono compatibility, verify correct positioning in surround sound mixes, determine relative phase in diagnostic applications, and evaluate the levels of each component in a stereo signal.

Applications of SpiderVision

The applications of the invention are legion. They include: audio recording, audio & video editing, audio & video post broadcast master control, compact disc mastering, duplicating plants, equipment maintenance, forensic evaluations, film sound scoring and mixing, live stereo sound mixing, location sound recording, quality control, and surround sound mixing.

2-Channel Program Signal Descriptors and Components

The left total audio signal Lt is given by
Lt=Lo+C+Surr, where (Eg. 1)
Lo are signal elements (SigE1) unique to left program channel (LPC) only;
C are equal level and in-polarity (wrt Rt) SigE1 common to both Lt and Rt; and
Surr are equal level but out-of-polarity (wrt Rt) SigE1 common to both Lt and Rt.

The right total audio signal Rt is given by:
Rt=Ro+C+(−Surr), where (Eq. 2)
Ro are signal elements (SigE1) unique to the right program channel (RPC) only;
C are equal level and in-polarity (wrt Lt) SigE1 common to both Lt and Rt; and
   Surr are equal level but out-of-polarity (wrt Lt) SigE1 common to both Lt and Rt. This signal will be inverted in polarity relative to the L+Surr component.

Taking the sum and difference of Lt and Rt results in the following:
Lt+Rt=(Lo+C+Surr)+(Ro+C+(−Surr))
Lt+Rt=Lo+Ro+2C (Eq. 3)
Lt−Rt=(Lo+C+Surr)−(Ro+C+(−Surr))
Lt−Rt=Lo+(−Ro)+2Surr (Eq. 4)

Comparison of 2-Channel Program Reproduction Formats

| PROGRAM | 4-Channel/5-Speaker | 2-Speaker | Mono Sum Result |
|---|---|---|---|
| COM- | Dolby Pro Logic ™ | (Stereo) | (Depending on |
| PONENT | Reproduction | Reproduction | program content) |
| Lt | N/A | Reproduced by Left | Adds either 10 Log or |
| | | Speaker Only | 20 Log with Rt |
| Rt | N/A | Reproduced by Right | Adds either 10 Log or |
| | | Speaker Only | 20 Log with Lt |
| Lo | Will Be Steered to Left | Reproduced by Left | Adds either 10 Log or |
| | Front Speaker only | Speaker Only | 20 Log with Lt |
| Ro | Will Be Steered to Right | Reproduced by Right | Adds either 10 Log or |
| | Front Speaker only | Speaker Only | 20 Log with Lt |
| C | Will Be Steered to | Reproduced by | Adds (20 Log) Partial |
| | Center Speaker Only | Both Speakers | Cancellation if not Equal |
| | | | Level and φ |
| Surr | Will Be Steered to | Reproduced by | Completely Cancels |
| | Rear Speakers only | Both Speakers | (1 − 1 = 0) |
| | | | [If Equal Level in Both |
| | | | Channels & no Interchannel |
| | | | φ Distortion] |

The SpiderGraph Display

The raw audio Lt and Rt are processed in the SpiderVision display processor, according to the invention, which generates X and Y coordinates for each Lt and Rt point. The hardware and software algorithms acquire samples of audio stream and convert them to their respective X and Y coordinates for display as scatter diagram called SpiderMesh. The SpiderMesh is displayed continuously, tracking the audio stream.

The SpiderMesh has a central tendency, which is an arithmetic mean of all the points at a particular instance. The mean of all points above the X-axis (+/−X, +Y only), corresponding to frontal sound becomes the end point of a forward vector. At the same time the mean of all points below the X-axis (+/−X, −Y only), corresponding to surround sound becomes the end point of a surround vector. The origin of both these vectors is (0, 0). A straight-line plot between the origin and end points draws these vectors. For visual clarity, appropriate gain may be applied to these vectors.

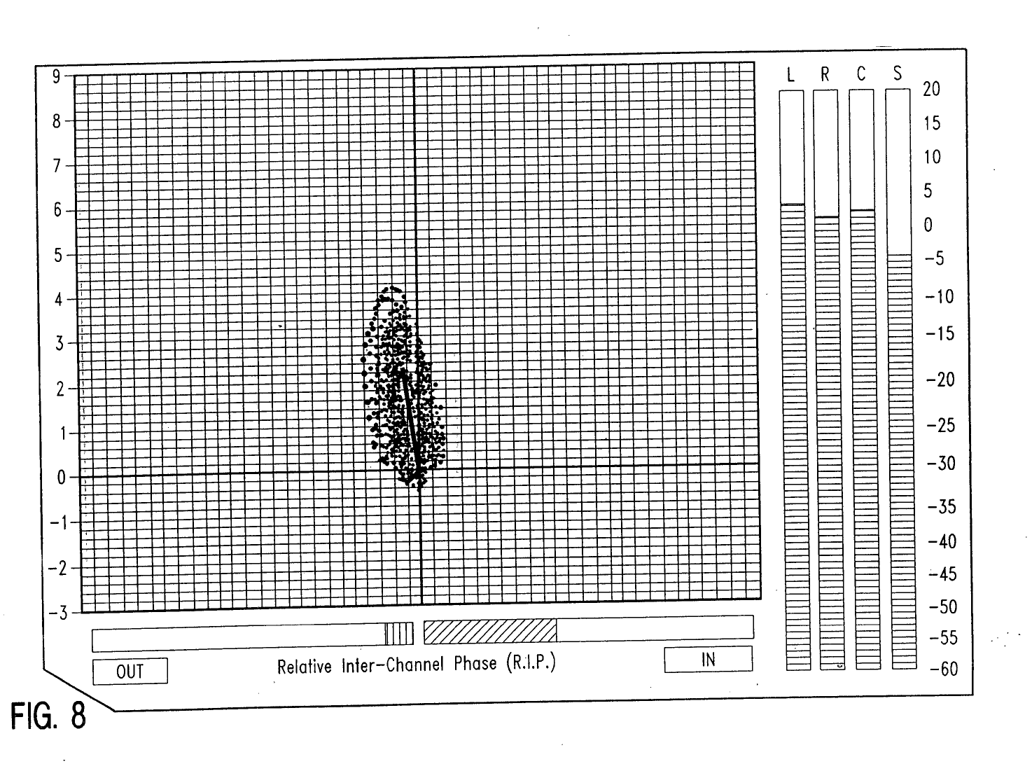

FIGS. 8, 9 and 10 are a series of screen images of actual SpiderGraph displays. The phase bars at the bottom of the display form no part of the invention.

The bars indicated to the right of the X-Y display indicate, in decibels, the instantaneous values of Lo, Ro, C and Surr. Within the X-Y display itself, the SpiderMesh, which may be displayed in a distinctive color, represents a plurality of points, for example, 1000 points, which were derived from the signals Lt and Rt by a display processor, as will be described below. Relative in-phase components of the signals Lt and Rt are represented as positive Y coordinate points in the image (indicating the “frontal sound”) whereas relative out-of-phase components of the signals Lt and Rt are represented as negative Y coordinate points in the image (indicating “surround sound”). Originating from the center of the X-Y display and extending in a positive Y direction and a negative Y direction, respectively, are two SpiderVectors, preferably each displayed in a separate color.

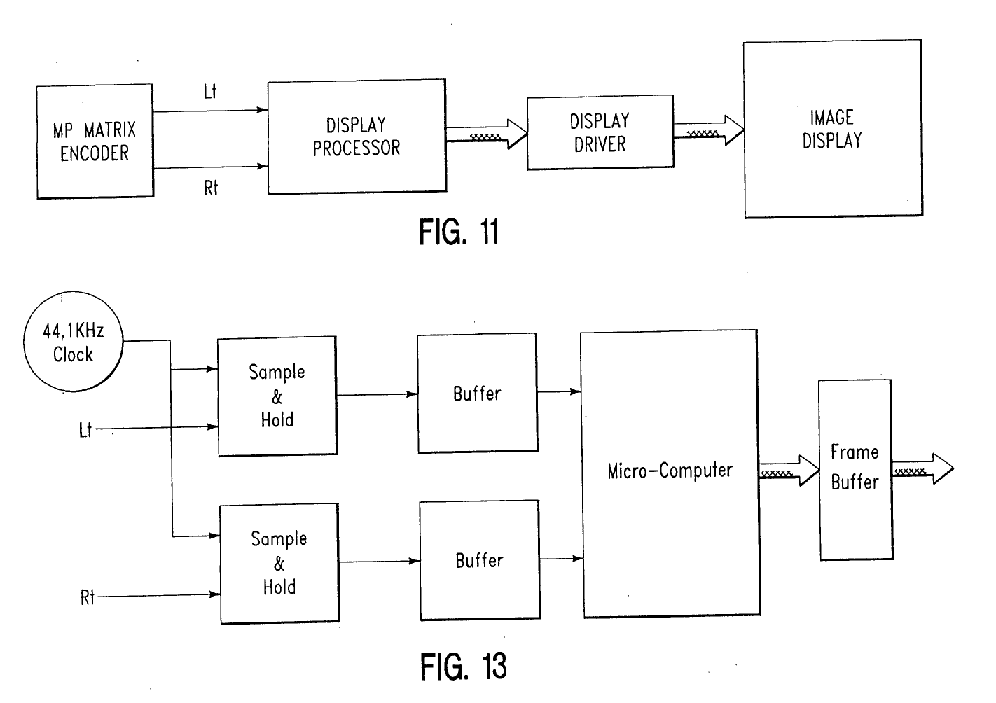

FIG. 11 illustrates the essential elements of the SpiderVision system according to the present invention. The left total audio signal Lt and the right total audio signal Rt are obtained from a Dolby “MP Matrix Encoder”. Details of this encoder are set forth in the aforementioned article “Dolby Surround Pro Logic Decoder Principles of Operation”. Signals Lt and Rt are supplied to a display processor, according to the invention, which will be described in detail below. This display processor may be implemented either as an analog or a digital embodiment. The output of the display processor is passed to a display driver which creates the image on an image display, such as an LCD or CRT display. SpiderVision images, such as those shown in FIGS. 8, 9 and 10, are formed on this display.

Analog Implementation of SpiderVision

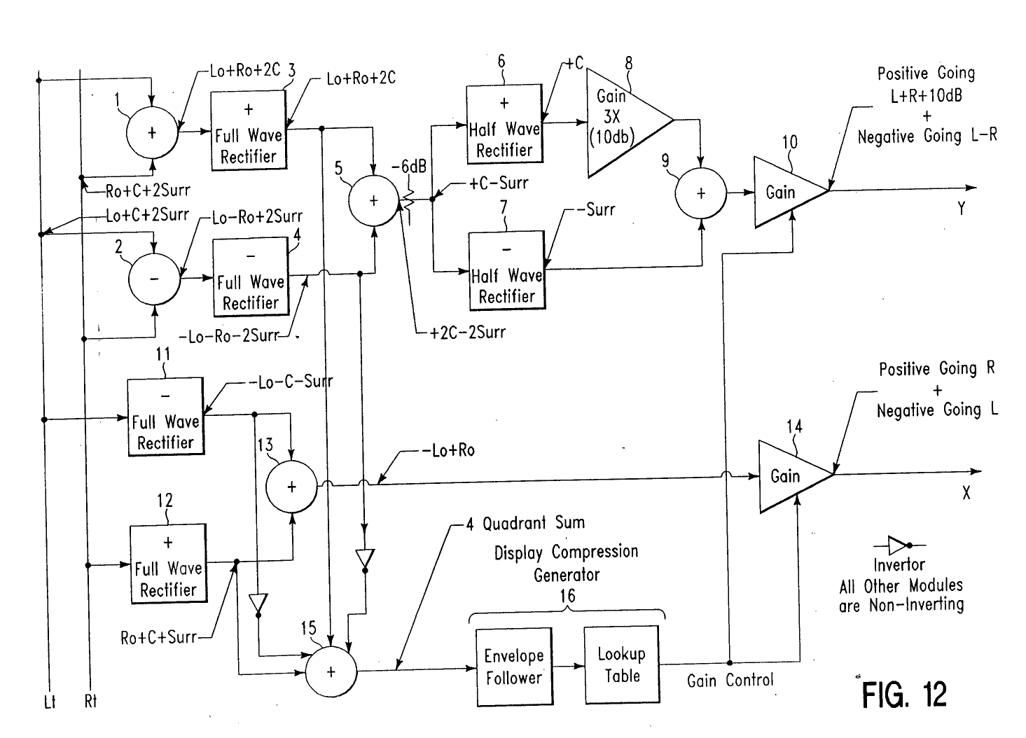

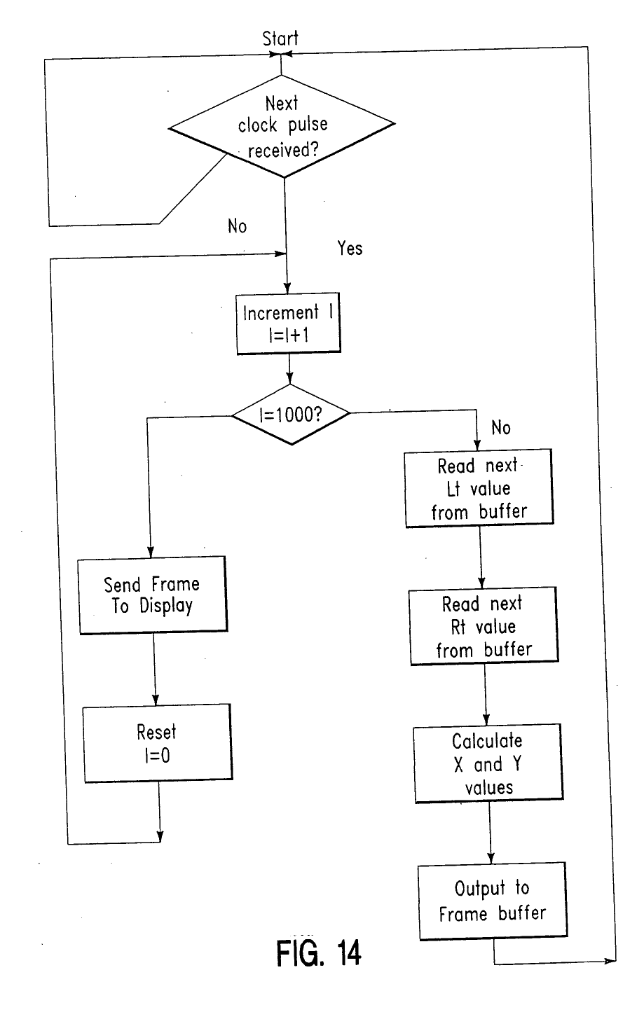

The display processor according to the invention generates the X and Y output signals which create a SpiderMesh on the image display. Although the display processor is preferably implemented digitally, as will be described below in connection with FIGS. 13 and 14, it may also be implemented in analog form as illustrated in FIG. 12. This analog implementation of the SpiderVision display processor will now be described in connection with FIG. 12.

Dolby surround-encoded Lt and Rt program information is distributed to sum 1 and difference 2 nodes and to full wave rectifiers 11 and 12.

Sum 1 node output consists of all program material minus the surround information, and the difference 2 node output consists of all program material minus the center information, as set forth in Equations 3 and 4 above. These signals are then rectified by full wave rectifiers 3 and 4 and then combined into a bipolar DC signal at sum node 5.

The output of sum node 5 consists of negative-going surround information and positive-going center information. This signal is then split into uni-polar DC components by half wave rectifiers 6 and 7.

The +C signal, which forms the +Y component of Y-axis, is boosted +10 dB by 8. The +C and −Surr signals are then recombined at node 9 and fed to variable gain stage 10 to form the Y-axis output stage.

The full wave rectifier 11 converts Lt program information into a negative-going DC voltage. The full wave rectifier 12 converts Rt program information into a positive-going DC voltage.

Sum node 13 combines these two signals into a bipolar DC signal consisting of −Lo++Ro. This signal is fed to variable gain X-axis output stage 14.

Sum node 15 receives non-inverted output signals form full wave rectifiers 3 and 12, and inverted output signals from full wave rectifiers 4 and 11. The output signal developed by sum node 15 is then processed by display compression generator 16, and subsequently delivered to the gain-control inputs of the X-axis and Y-axis output stages 10 and 14. These signals are then processed by the display driver to produce a modified “X-Y” type of screen display. The display compression generator 16 creates a dc signal that controls the gain of the X and Y channels to allow a dB scaling of the display over some specified range. It may also allow for calibration and range selection.

Digital Implementation of SpiderVision

The raw audio Lt and Rt are processed in a digital display processor as shown in FIG. 13, which generates X and Y coordinates for each Lt and Rt point. The sample and hold circuits acquire samples of the audio stream sends the samples to a microcomputer which converts them to their respective X and Y co-ordinates for display as the scatter diagram called SpiderMesh. The SpiderMesh is displayed continuously, tracking the audio stream.

The microcomputer performs the same processing functions as does the analog circuit of FIG. 12.

The left (Lt) and right (Rt) audio inputs to the surround sound display processor consist of:
Lt=Lo+C+Surr (Eq. 1)
Rt=Ro+C+(−Surr) (Eq. 2)

For every instance of left (Lt) and right (Rt) audio input, the algorithm of the display processor software generates a corresponding X and Y coordinate point to be displayed on the X-Y plot, where
Y=+C+(−Surr) (Eq. 5)
X=−Lo+Ro (Eq. 6)

The acquisition of the analog audio signals into digital domain is done according to Nyquist Sampling Criterion; that is at a frequency which is at least twice the frequency of the signals Lt and Rt. The sampling frequency (f) is 44,100 Hz. This means that an audio sample is obtained every 22.6 microseconds.

Since the acquisition of the left (Lt) and right (Rt) channel is simultaneous, and 1000 sample points are acquired for each video frame, it would take 22.6 microseconds×1000=22.6 ms to acquire these 1000 samples. In reality this time may be slightly higher due to processing time, but it remains at about one frame, or under 30 ms, tracking 30 frames per second of video.

To build a scatter plot 1000 points are collected for the left channel and 1000 points for the right channel. These are processed as described above to generate 1000 points to be plotted on the X-Y Plot. These 1000 points on the X-Y plots are called SpiderMesh, since they will be distributed according to the sound field present at that time. The process is then repeated over again.

The generation of SpiderMesh results in left (Lt) and right (Rt) channel audio signals being converted to X and Y coordinates for display on the X-Y plot. If the plot is refreshed every 1000 points, as detailed above, then at any given time 1000 points in XY coordinates, representing the current sound field, are displayed.

These 1000 Points are separated into two groups:
(1) A “frontal group” consisting of all points where Y-coordinate is positive, irrespective of their corresponding X-coordinate value; and
(2) A “surround group” consisting of all points where Y-coordinate is negative, irrespective their corresponding X-coordinate value.

An arithmetic mean is taken of all points in the frontal group (the mean of all X-coordinates and mean of all Y-coordinates), to determine one single X-Y coordinate point which represents average value of only the frontal sound field, as depicted by the SpiderMesh, above the X-axis. This is the Forward SpiderVector end point.

The arithmetic mean is taken of all points in the surround group (the mean of all X-coordinates and mean of all Y-coordinates), to determine one single X-Y coordinate point which represents average value of only the surround sound field, as depicted by the SpiderMesh, below the X-axis. This is the Surround SpiderVector end point.

Lines drawn from the origin (0,0) to the two end points obtained as described above produce the two SpiderVectors: the Forward Vector and Surround Vector.

These SpiderVectors are generated afresh each time the SpiderMesh is updated.

FIG. 13 is a block diagram showing the preferred embodiment of the digital implementation of the display processor. Raw signals Lt and Rt are continuously sampled at a 44.1 KHz rate and the samples are supplied to a microcomputer. This microcomputer operates in accordance with the flow chart of FIG. 14 to calculate 1000 X-Y coordinate points for each frame and then output the frames to a frame buffer at the 30 frame per second rate.

There has thus been shown and described a novel apparatus for generating and displaying images for determining the quality of audio reproduction which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

1. Apparatus for generating and displaying images for determining the quality of audio reproduction in a surround sound system that produces a left total audio signal (“Lt signal”) and a right total audio signal (“Rt signal”), said apparatus comprising:
(a) a left audio signal input for receiving the signal Lt;
(b) a right audio signal input for receiving the signal Rt;
(c) a display processor connected to said left and right audio inputs and having a display control output, for producing a display control signals at said output in dependence upon said signals Lt and Rt; and
(d) a graphic image display, coupled to said display control output, for displaying a two-dimensional image within an X and Y coordinate system, wherein relative in-phase components of said signals Lt and Rt are represented as positive Y coordinate points in the image, wherein relative out-of-phase components of said signals Lt and Rt are represented as negative Y coordinate points in the image, and wherein the respective amplitudes of the signals Lt and Rt are represented as negative X and positive X coordinate points, respectively, in the image.

2. The apparatus defined in claim 1, wherein the signal Lt is comprised of signal elements unique to the left sound channel only (Lo), plus equal level and in-polarity signal elements common to both Lt and Rt (C), plus equal level but out-of-polarity signal elements common to both Lt and Rt (Surr).

3. The apparatus defined in claim 1, wherein the signal Rt is comprised of signal elements unique to the right sound channel only (Ro), plus equal level and in-polarity signal elements common to both Lt and Rt (C), minus equal level but out-of-polarity signal elements common to both Lt and Rt (−Surr).

4. The apparatus defined in claim 1, wherein the display processor calculates each X-Y coordinate point for display in accordance with the formulae:
Y=C+(−Surr); and
X=−Lo+Ro; where
Lo are signal elements unique to the left sound channel only, Ro are signal elements unique to the right sound channel only, C are equal level and in-polarity signal elements common to both signals Lt and Rt, and Surr are equal level but out-of-polarity signal elements common to both signals Lt and Rt.

5. The apparatus defined in claim 1, wherein the display processor processes the signals Lt and Rt in analog form, to produce analog display control signals at said output.

6. The apparatus defined in claim 5, wherein said display processor produces an analog X coordinate control signal by summing the outputs of (1) a first full wave rectifier which is connected to the left audio signal input to receive the signal Lt and which produces a negative output signal, and (2) a second full wave rectifier which is connected to the right audio signal input to receive the signal Rt and which produces a positive output signal.

7. The apparatus defined in claim 5, wherein said display processor produces an analog Y coordinate control signal by first producing first and second intermediate signals representing the sum and difference, respectively, of the signals Lt and Rt; passing the first intermediate signal though a first full wave rectifier which produces a positive third intermediate signal; passing the second intermediate signal through a a second full wave rectifier which produces a negative fourth intermediate signal; summing the third and fourth intermediate signals to produce a fifth intermediate signal; passing the fifth intermediate signal through a first half wave rectifier to produce a positive sixth intermediate signal; passing the fifth intermediate signal through a second half wave rectifier to produce a seventh intermediate signal and summing the sixth and seventh intermediate signals.

8. The apparatus defined in claim 6, wherein the display processor further comprises a display compression generator connected to a gain control amplifier at said output to adjust the gain of the X coordinate control signal.

9. The apparatus defined in claim 7, wherein the display processor further comprises a display compression generator connected to a gain control amplifier at said output to adjust the gain of the Y coordinate control signal.

10. The apparatus defined in claim 7, wherein the display processor further comprises an amplifier connected to the output of said first half wave rectifier to increase the gain of said sixth intermediate signal.

11. The apparatus defined in claim 1, wherein the display processor samples the signals Lt and Rt at a given sampling frequency to produce digital signals and processes the digital signals in digital form to produce digital display control signals at said output.

12. The apparatus defined in claim 11, wherein the display processor samples the signals Lt and Rt at a frequency which is at least twice the maximum frequency of the the signals Lt and Rt.

13. The apparatus defined in claim 11, wherein the display processor calculates the digital X and Y coordinates of each successive point to be displayed.

14. The apparatus defined in claim 13, wherein the display processor stores a plurality of points to produce a scatter plot as a single image frame and thereafter passes said image frame to said output for display.

15. The apparatus defined in claim 14, wherein a plurality of image frames, each comprising said plurality of points, are displayed in succession to form a video image.

16. The apparatus defined in claim 14, wherein said display processor calculates the arithmetic mean point of all points in said scatter plot for which the Y coordinate is positive, and generates a first line from an origin where X and Y are both zero to said positive arithmetic mean point, for imaging on said display.

17. The apparatus defined in claim 14, wherein said display processor calculates the arithmetic mean point of all points in said scatter plot for which the Y coordinate is negative, and generates a second line from an origin where X and Y are both zero to said negative arithmetic mean point, for imaging on said display.

18. The apparatus defined in claim 16, wherein said first line is displayed in color.

19. The apparatus defined in claim 17, wherein said second line is displayed in color.
